(19) United States
(12) Patent Application Publication
(10) Pub. No.: US 2003/0181288 A1
(43) Pub. Date: Sep. 25, 2003

(54) Drive efficiency enhancing system

(76) Inventor: Gary E. Phillippe, North Highlands, CA (US)

Correspondence Address: James M. Ritchey, O'BANION and RITCHEY, Wells Fargo Center, 400 Capitol Mall, Suite 1550, Sacramento, CA, 95814, US

(21) Appl. No.: 10/103,042

(22) Filed: Mar. 21, 2002

(51) Int. Cl. H02P 7/00

(52) U.S. Cl. 477/7

(57) ABSTRACT

An electromechanical coupler for enhancing the energy consumption efficiency of linking a drive to an output device. The system comprises a lever arm bracket, an elongated lever arm with first and second ends and pivotally mounted to the bracket, a connection for associating the drive to the first end of the lever arm, a rotational output drive shaft coupled to the output device, a linkage for associating the lever arm second end to the output drive shaft, and an energy input controller associated with the output drive shaft that is in electrical communication with the drive for activating and deactivating at selected time intervals the flow of energy to the drive.

### BACKGROUND OF THE INVENTION

1. Field of the Invention

A system for increasing the efficiency of a drive is disclosed. More particularly, the subject system comprises an electromechanical coupler that decreases the amount of required energy, in particular electric energy, for operating a drive, in particular an electric drive, which is coupled to an output device, thereby increasing efficiency by lowering energy, in particular electric energy, input.

2. Description of the Background Art

Drives of various forms, such as an internal combustion engine, an electric motor, an electric/magnetic solenoid and the like are frequently coupled to various output devices to perform work. Means for coupling of the drive to any particular output device is usually an inefficient and energy wasting proposition. The subject system increases the efficiency of the coupling process by lowering the amount of energy needed to operate the drive by timing the application of energy to the drive based on a controller linked to an output device coupling means.

A method and apparatus for controlling an oil well walking beam pump is discussed in U.S. Pat. No. 5,204,595. An electric drive motor is coupled to a reciprocating mechanical system having a walking beam wherein motor current is caused to increase and decrease cyclically due to torque output demands imposed on the drive gear. The current is ramped up at preselected points in the operating cycle.

U.S. Pat. No. 5,425,623 uses the power drawn by the load to determine the phase angle of the pump without the need for a separate phase signaling sensor.

U.S. Pat. No. 3,646,833 discloses a counterbalancing system for oilfield pump jacks. A hydraulic fluid and air pressure counterbalancing system has a smaller diameter ram interconnected to a larger diameter accumulator vessel.

An oil well pump off control system that utilizes an integration timer is found in U.S. Pat. No. 3,930,752. A flow control system operates a valve in the flow line of an oil well such that the valve is shut during the downstroke of the pumping assembly when no production is occurring.

U.S. Pat. No. 3,959,967 relates a reciprocating apparatus particularly for a pump unit that maintains a permanent reciprocatory movement of a mechanical arrangement.

Presented in U.S. Pat. No. 4,099,447 is an hydraulically operated oil well pump jack. A double acting hydraulically operated piston and cylinder assembly for pivoting the walking beam is shown. Included is a linkage mechanism for operating a reversing valve to cause extension and retraction of the piston and cylinder assembly for oscillating the beam, thereby causing pumping to occur.

U.S. Pat. No. 4,102,394 outlines a control unit for a pump. A variable speed/cycle AC motor is utilized in maximizing the efficiency of a producing oil field. An operator controls the strokes per minute and the speed of the upstroke relative to the downstroke in the efficiency process. The speed adjustment minimizes undue or excessive pounding against fluid columns, thereby lessening shock and vibration. Included are other control factors such as temperature, flow, chemical analysis, and the like.

A switching power supply is described in U.S. Pat. No. 4,471,418. Primarily the maximum power output is limited during various line voltages within a predetermined range on a cycle by cycle basis. A measured interrelationship between the primary and secondary winding currents and voltages of a power supply transformer are utilized in the process.

U.S. Pat. No. 4,873,635 depicts a pump-off control that simply measures the length of time required for the pump to downstroke a successive numbers of times and when the time differential reaches a predetermined value, the pump is shut off for a time period. A magnetic sensor measures each revolution of the crankshaft in the process.

A rod pump optimization system is related in U.S. Pat. No. 4,854,164. The system measures the quantity and flow rate of liquids in a flowing fluid stream containing liquids and gases and employs a controller to control the pumping period or speed based on pump displacement.

The foregoing patents reflect the state of the art of which the applicant is aware and are tendered with the view toward discharging applicant's acknowledged duty of candor in disclosing information which may be pertinent in the examination of this application. It is respectfully submitted, however, that none of these patents teach or render obvious, singly or when considered in combination, applicant's claimed invention.

### SUMMARY OF THE INVENTION

An object of the present invention is to provide an apparatus that enhances the efficiency of coupling a drive to a output device.

Another object of the present invention is to disclose an apparatus that controls power to a drive, thereby increasing energy efficiency by activating the power only when appropriate and deactivating the power when the power is not necessary.

A further object of the present invention is to describe an electromechanical coupler for enhancing the energy consumption efficiency of linking a drive to an output device.

Still another object of the present invention is to present an electromechanical coupler for enhancing the energy consumption efficiency of linking an electric drive to an output device, wherein the coupler includes a controller that activates, when required, and deactivates, when not required, electric power to the drive.

Yet a further object of the present invention is to relate an energy saving electromechanical coupler for linking an electric drive to an output device and includes a controller that minimizes the electricity required by the drive by selectively activating and deactivating the electricity delivered to the drive.

Disclosed is an electromechanical coupler for enhancing the energy consumption efficiency of linking a drive means to an output device. Usually, the energy consumed is electric energy and the drive is an electric drive, but the subject invention may be utilize an energy source such as gasoline and a drive such as an internal combustion engine and equivalents. Generally, the subject invention comprises a lever arm bracket, an elongated lever arm having first and second end regions and pivotally mounted to said bracket, connecting means for associating the drive means to proximate said lever arm first end region, a rotational output drive shaft coupled to the output device, linking means for associating said lever arm second region to said output drive shaft, and energy input gating means secured to said output drive shaft and in electrical communication with the drive means for activating and deactivating at selected time intervals the flow of energy to the drive means, thereby resulting in an efficiency enhancement.

For an electric drive, comprising the subject system is a lever arm bracket, an elongated lever arm having first and second end regions and pivotally mounted to the bracket, and connecting means for associating the electric powered drive means to proximate the lever arm first end region. The connection means comprises first rotational anchoring means associated with the lever arm first end region and first attachment means extending between the first rotational anchoring means and the electric power drive means. The first attachment means comprises a first coupling rod with first and second ends, wherein the first coupling rod first end is rotationally mounted to the rotational anchoring means, a first wheel with an outer perimeter, wherein the first coupling rod second end rotationally attaches proximate the first wheel outer perimeter, and first linkage means for connecting the first wheel to the electric power drive means, wherein the electric power drive means is an electric motor.

Additionally, comprising the subject invention is a rotational output drive shaft coupled to the output device and linking means for associating the lever arm second region to the output drive shaft. The linking means for associating the lever arm second region to the output drive shaft comprises second rotational anchoring means associated with the lever arm second end region and second attachment means extending between the second rotational anchoring means and the output drive shaft. The second attachment means comprises a second coupling rod with first and second ends, wherein the second coupling rod first end is rotationally mounted to the second rotational anchoring means, a second wheel with an outer perimeter, wherein the second coupling rod second end rotationally attaches proximate the second wheel outer perimeter, and second linkage means for connecting the second wheel to the output device.

Further included in the subject invention is an electricity input gating means secured to the output drive shaft and in electrical communication with the electric powered drive means for activating and deactivating at selected time intervals the flow of electricity to the electric powered drive means.

The electricity input gating means comprises means for detecting a rotational position of the output drive shaft and means for activating and deactivating the flow of electricity to the electric power drive means based on the detected rotational position of the output drive shaft.

The rotational position detection means comprises optical sensors and the activating and deactivating means comprises a computer controller in communication between the optical sensors and the electric power drive means.

The electricity input gating means comprises a timing wheel having a center axis and first and second perimeter edges mounted through the center axis to the rotational output drive shaft. As the rotational output drive shaft rotates the timing wheel rotates and the first perimeter edge is at a greater distance from the center axis than the second perimeter edge. The electricity input gating means includes an electrical switch, wherein the electrical switch activates the flow of electricity to the electric powered drive means when the electrical switch encounters the first perimeter edge and deactivates the flow of electricity to electric powered drive means when the electrical switch encounters the second perimeter edge.

Other objects, advantages, and novel features of the present invention will become apparent from the detailed description that follows, when considered in conjunction with the associated drawings.

### BRIEF DESCRIPTION OF THE DRAWINGS

FIG. 1 is a perspective view of the subject invention utilizing an electric motor as the drive.

FIG. 2 is a perspective view of the subject invention utilizing an electric solenoid as the drive.

FIG. 3 is a side view of the subject invention with the drive energizing means in a first position.

FIG. 4 is a side view of the subject invention with the drive energizing means in a second position.

FIG. 5 is a top view of the subject invention with an electromechanical switch rotational position detection means and no particular drive shown.

FIG. 6 is a top view of the subject invention with an optical rotational position detection means and no particular drive shown.

### DESCRIPTION OF THE PREFERRED EMBODIMENT

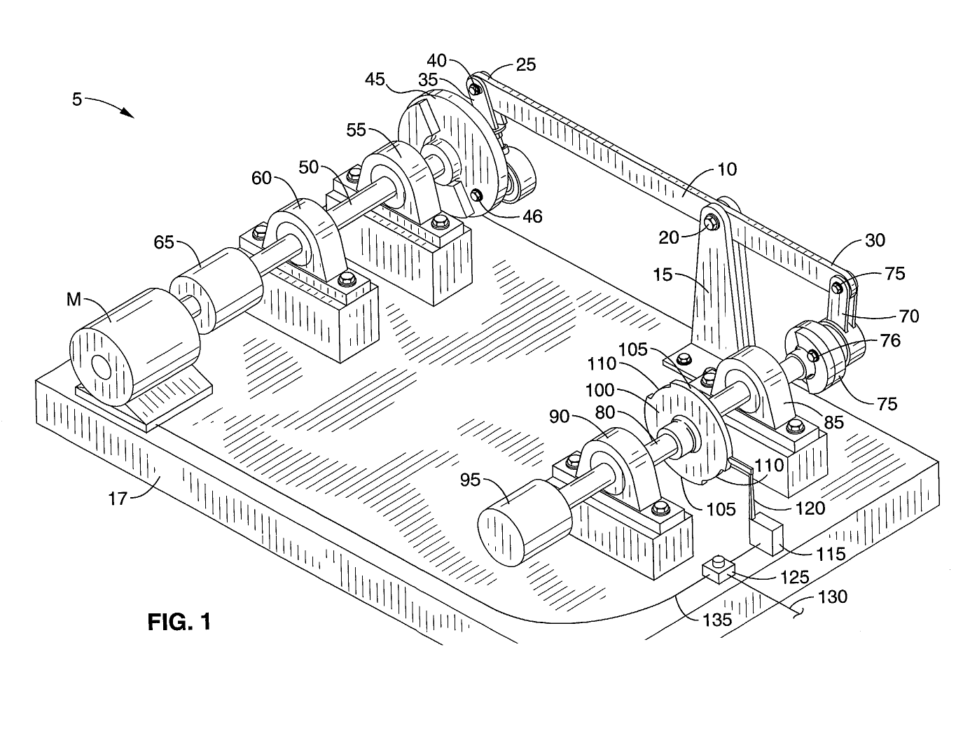

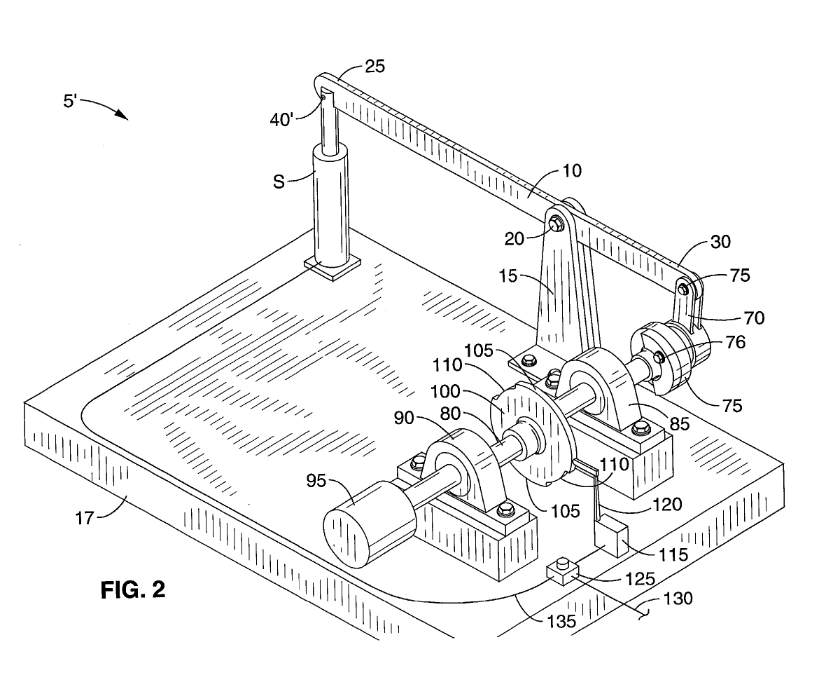

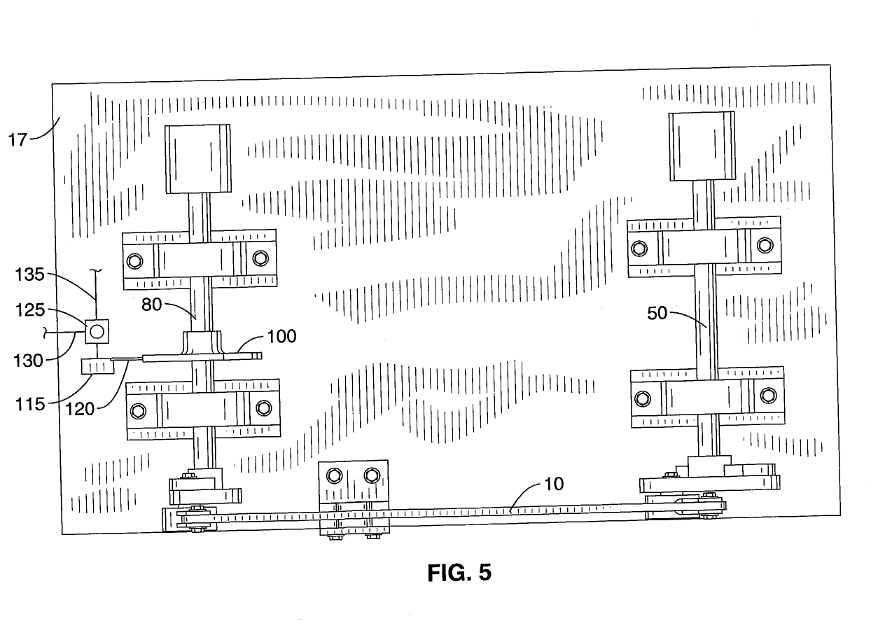

Referring now to FIGS. 1-5, there is shown preferred embodiments of the subject electromechanical coupler for enhancing the efficiency of linking a drive means to an output device. The energy efficiency enhancing system is utilized with a drive that is an electric motor, electric solenoid, internal combustion engine, and similar devices. In particular, the subject system is employed with electric devices such as a motor or solenoid in which the amount of supplied electricity is limited by a controller that monitors the rotational position of an output drive shaft. For exemplary purposes only and not by way of limitation, electric drive means will be depicted in FIGS. 1 and 2.

As seen in FIG. 1 for a first embodiment of the subject invention 5, an electric motor M is the drive means. An elongated lever arm or walking beam 10 is pivotally mounted to a lever arm bracket 15 which is secured to a base or supporting frame 17. The pivotal mounting is by standard means such as a suitable bearing 20 and the like. The lever arm 10 has first and second end regions 25 and 30. End region 25 is pivotally anchored to a first linkage arm 35 by a suitable bearing 40 or similar means. The first linkage arm or coupling rod 35 eventually leads to the electric drive motor M, via input connecting elements.

The connecting elements may be of various forms and provide the mechanical link to the electric drive motor. FIG. 1 shows the connecting elements to include a first wheel 45 pivotally connected to the first coupling rod 35 by a suitable bearing 46 or similar means. A rotational input drive shaft 50 is attached to the first wheel 45 and is supported by bearing assemblies 55 and 60. The input drive shaft 50 is coupled to the electric drive motor M by an appropriate input coupling 65.

Extending from the lever arm second end region 30 is a second coupling rod 70 that is pivotally secured to the lever arm 10 by a bearing 75 or similar means. The second coupling rod 70 eventually leads to an appropriate output device such as an engine, pump, ant the like via output connecting elements.

The output connecting elements may be of various forms and provide the mechanical link to the output device. FIG. 1 shows the output connecting elements to include a second wheel 75 pivotally connected to the second coupling rod 70 by a suitable bearing 76 or similar means. A rotational output drive shaft 80 is attached to the second wheel 75 and is supported by bearing assemblies 85 and 90. The output drive shaft 80 is coupled to an output device by an appropriate output coupling 95.

An energy input gating means is utilized to activate and deactivate the supply of energy (electricity in the case of an electric drive means) to the drive. The energy gating means comprises a means for detecting the rotational position of the output drive shaft 80 and means for activating and deactivating the flow of electricity to the drive based on the detected rotational position of the output drive shaft 80.

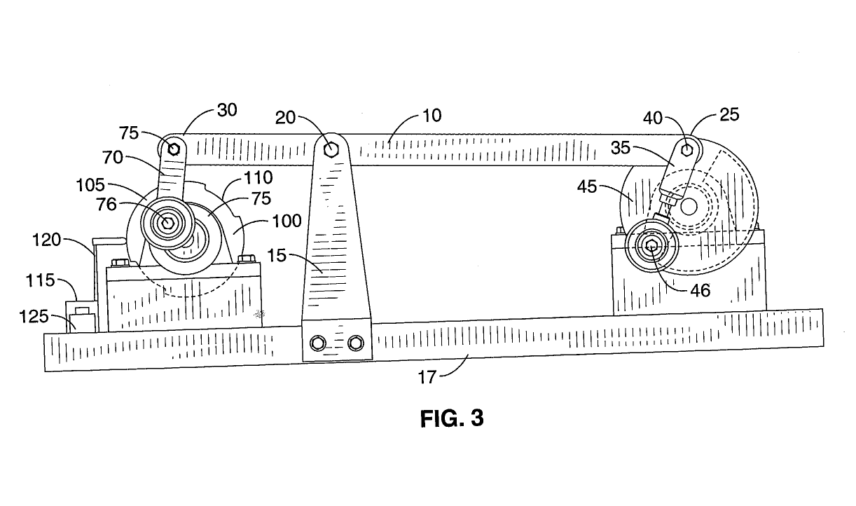

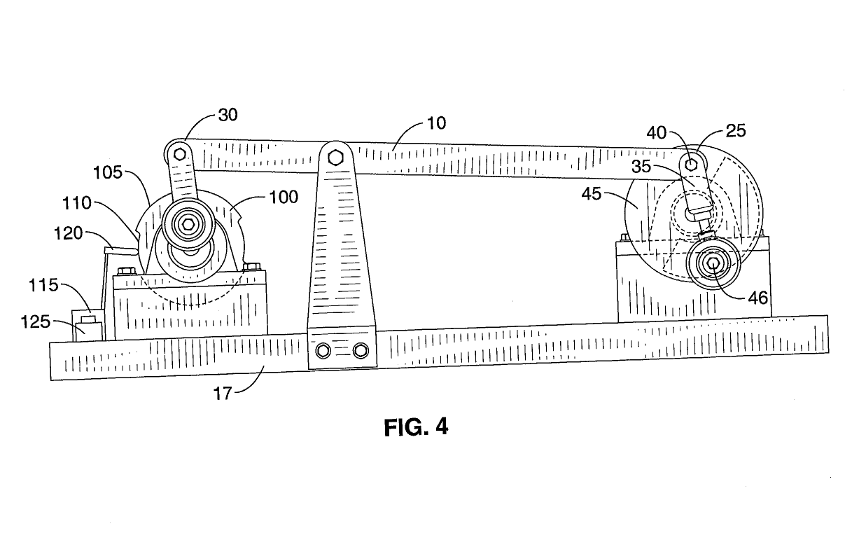

A first embodiment of the rotational position detection means is shown in FIGS. 1-5 and comprises a timing wheel 100 having a center axis and first 105 and second 110 perimeter edges mounted through the center axis to the rotational output drive shaft 80, wherein as the rotational output drive shaft 80 rotates the timing wheel 100 rotates and the first perimeter edge 105 is at a greater distance from the center axis than the second perimeter edge 110. An electrical switch 115 is present that has an on/off actuating arm 120 that rides on the outer perimeter of the timing wheel 100. The electrical switch 115 activates the flow of electricity to the electric drive motor M when the actuating arm 120 encounters the first perimeter edge 105 and deactivates the flow of electricity to the electric drive motor M when the actuating arm 120 encounters the second perimeter edge 110. This electricity flow regulation process is seen in detail in FIGS. 3 and 4. FIG. 3 illustrates the actuating arm 120 in the “on” position by riding on the first perimeter edge 105 of the timing wheel 100 which activates electricity to the motor M. FIG. 4 shows the actuating arm 120 in the “off” position by riding on the second perimeter edge 110 of the timing wheel 100 which deactivates electricity to the motor M. The timing wheel 100 has the transition between the inner 110 and outer 105 perimeters in a step-like configuration, however, it it stress that a smooth transition is contempleated, as are other equivalent transitional configurations.

The energy input gating means (the timing wheel 100 and switch 115) is in electrical communication with the drive motor M for activating and deactivating at selected time intervals the flow of energy to the drive motor M, thereby resulting in an efficiency enhancement. In particular, FIGS. 1-5 all depict a power controller 125 that adjusts the level of power from the power source connection 130 that is delivered to the motor M, via a suitable connection 135. The power controller may be as simple as a traditional rheostat or a more sophisticated form such as a suitable microchip or computer.

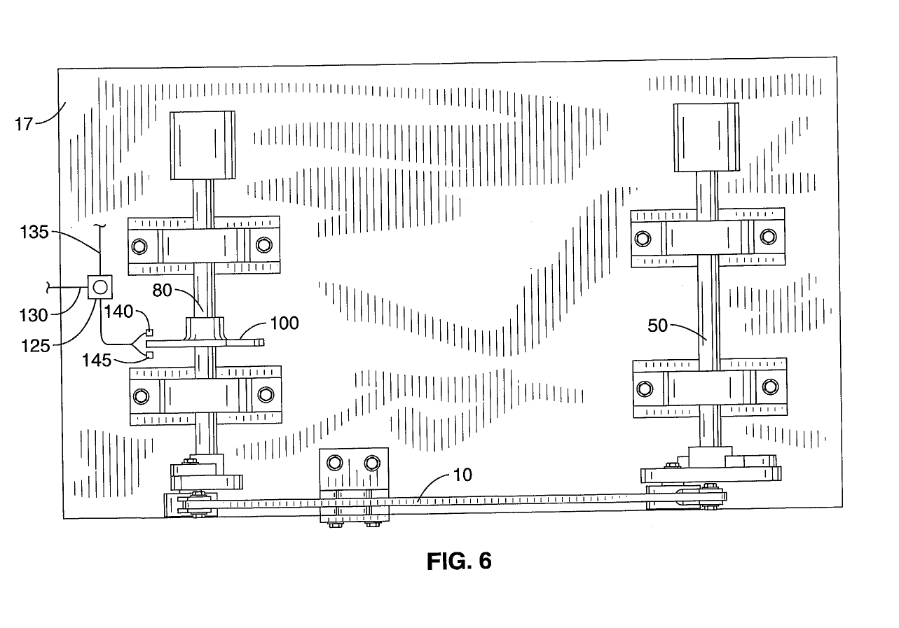

As seen in FIG. 6, a second embodiment of the rotational position detection means may comprise optical sensors 14 and 145 and the activating and deactivating means comprises a computer controller 125 in communication between the optical sensors and the electric drive. Optical means may be utilized as the rotational position detection means. FIG. 6 shows an optical emitter 140 and optical receiver 145 as the paired optical means. Clearly, other equivalent configuration of the optical means are within the realm of this disclosure. Plainly, the computer controller 125 is programmed with suitable instruction to activate and deactivate the drive upon the optical sensors detecting a gap in the timing wheel outer perimeter. Also, other equivalent optical or magnetic means may be employed at any suitable location that enables the system to detect rotation of the output shaft 80 and activate and deactivate power to the drive.

Shown in FIG. 2 is a second embodiment of the subject invention 5′, with an electric solenoid S as the drive means. The elongated lever arm or walking beam 10 first end region 25 is pivotally anchored to the solenoid by a suitable bearing 40′ or similar means. The other elements of the second embodiment are identical to those found in the first embodiment (identical numbers are used to label each element).

The invention has now been explained with reference to specific embodiments. Other embodiments will be suggested to those of ordinary skill in the appropriate art upon review of the present specification.

Although the foregoing invention has been described in some detail by way of illustration and example for purposes of clarity of understanding, it will be obvious that certain changes and modifications may be practiced within the scope of the appended claims.

What is claimed is:

1. An electromechanical coupler for enhancing the efficiency of linking a drive means to an output device, comprising:
a) a lever arm bracket;
b) an elongated lever arm having first and second end regions and pivotally mounted to said bracket;
c) connecting means for associating the drive means to proximate said lever arm first end region;
d) a rotational output drive shaft coupled to the output device;
e) linking means for associating said lever arm second region to said output drive shaft; and
f) energy input gating means secured to said rotational output drive shaft and in electrical communication with the drive means for activating and deactivating at selected time intervals the flow of energy to the drive means, thereby resulting in an efficiency enhancement.

2. An electromechanical coupler for enhancing the electric consumption efficiency of linking an electric powered drive means to an output device, comprising:
a) a lever arm bracket;
b) an elongated lever arm having first and second end regions and pivotally mounted to said bracket;
c) connecting means for associating the electric powered drive means to proximate said lever arm first end region;
d) a rotational output drive shaft coupled to the output device;
e) linking means for associating said lever arm second region to said output drive shaft; and
f) electricity input gating means secured to said output drive shaft and in electrical communication with the electric powered drive means for activating and deactivating at selected time intervals the flow of electricity to the electric powered drive means.

3. An electromechanical coupler according to claim 2, wherein said connecting means for associating the electric powered drive means to proximate said lever arm first end region comprises:
a) first rotational anchoring means associated with said lever arm first end region and
b) first attachment means extending between said first rotational anchoring means and the electric power drive means.

4. An electromechanical coupler according to claim 3, wherein said first attachment means comprises:
a) a first coupling rod with first and second ends, wherein said first coupling rod first end is rotationally mounted to said rotational anchoring means;
b) a first wheel with an outer perimeter, wherein said first coupling rod second end rotationally attaches proximate said first wheel outer perimeter; and
c) first linkage means for connecting said first wheel to the electric power drive means, wherein said electric power drive means is an electric motor.

5. An electromechanical coupler according to claim 2, wherein said linking means for associating said lever arm second region to said output drive shaft comprises:
a) second rotational anchoring means associated with said lever arm second end region and
b) second attachment means extending between said second rotational anchoring means and said output drive shaft.

6. An electromechanical coupler according to claim 5, wherein said second attachment means comprises:
a) a second coupling rod with first and second ends, wherein said second coupling rod first end is rotationally mounted to said second rotational anchoring means;
b) a second wheel with an outer perimeter, wherein said second coupling rod second end rotationally attaches proximate said second wheel outer perimeter; and
c) second linkage means for connecting said second wheel to the output device.

7. An electromechanical coupler according to claim 2, wherein said electricity input gating means comprises:
a) means for detecting a rotational position of said output drive shaft and
b) means for activating and deactivating the flow of electricity to the electric power drive means based on said detected rotational position of said output drive shaft.

8. An electromechanical coupler according to claim 7, wherein said rotational position detection means comprises optical sensors and said activating and deactivating means comprises a computer controller in communication between said optical sensors and said electric power drive means.

9. An electromechanical coupler according to claim 2, wherein said electricity input gating means comprises:
a) a timing wheel having a center axis and first and second perimeter edges mounted through said center axis to said rotational output drive shaft, wherein as said rotational output drive shaft rotates said timing wheel rotates and said first perimeter edge is at a greater distance from said center axis than said second perimeter edge and
b) an electrical switch, wherein said electrical switch activates the flow of electricity to the electric powered drive means when said electrical switch encounters said first perimeter edge and deactivates the flow of electricity to electric powered drive means when said electrical switch encounters said second perimeter edge.

10. An electromechanical coupler for enhancing the electric consumption efficiency of linking an electric motor to an output device, comprising:
a) a supporting frame;
b) a lever arm bracket fastened to said supporting frame;
c) an elongated lever arm having first and second end regions and pivotally mounted to said bracket;
d) connecting means for associating the electric motor to proximate said lever arm first end region;
e) a output drive shaft coupled to the output device;
f) linking means for associating said lever arm second region to said output drive shaft; and
g) electricity input gating means secured to said output drive shaft and in electrical communication with the electric motor for activating and deactivating at selected time intervals the flow of electricity to the electric motor.

11. An electromechanical coupler according to claim 10, wherein said connecting means for associating the electric motor to proximate said lever arm first end region comprises:
a) first rotational anchoring means associated with said lever arm first end region and
b) first attachment means extending between said first rotational anchoring means and the electric motor.

12. An electromechanical coupler according to claim 11, wherein said first attachment means comprises:
a) a first coupling rod with first and second ends, wherein said first coupling rod first end is rotationally mounted to said rotational anchoring means;
b) a first wheel with an outer perimeter, wherein said first coupling rod second end rotationally attaches proximate said first wheel outer perimeter; and
c) first linkage means for connecting said first wheel to the electric motor.

13. An electromechanical coupler according to claim 10, wherein said linking means for associating said lever arm second region to said output drive shaft comprises:
a) second rotational anchoring means associated with said lever arm second end region and
b) second attachment means extending between said second rotational anchoring means and said output drive shaft.

14. An electromechanical coupler according to claim 13, wherein said second attachment means comprises:
a) a second coupling rod with first and second ends, wherein said second coupling rod first end is rotationally mounted to said second rotational anchoring means;
b) a second wheel with an outer perimeter, wherein said second coupling rod second end rotationally attaches proximate said second wheel outer perimeter; and
c) second linkage means for connecting said second wheel to the output device.

15. An electromechanical coupler according to claim 10, wherein said electricity input gating means comprises:
a) means for detecting a rotational position of said output drive shaft and
b) means for activating and deactivating the flow of electricity to the electric motor based on said detected rotational position of said output drive shaft.

16. An electromechanical coupler according to claim 15, wherein said rotational position detection means comprises optical sensors and said activating and deactivating means comprises a computer controller in communication between said optical sensors and said electric motor.

17. An electromechanical coupler according to claim 10, wherein said electricity input gating means comprises:
a) a timing wheel having a center axis and first and second perimeter edges mounted through said center axis to said rotational output drive shaft, wherein as said rotational output drive shaft rotates said timing wheel rotates and said first perimeter edge is at a greater distance from said center axis than said second perimeter edge and
b) an electrical switch, wherein said electrical switch activates the flow of electricity to the electric motor when said electrical switch encounters said first perimeter edge and deactivates the flow of electricity to electric motor when said electrical switch encounters said second perimeter edge.

18. An electromechanical coupler for enhancing the electric consumption efficiency of linking an electric powered drive means to an output device, comprising:
a) a lever arm bracket;
b) an elongated lever arm having first and second end regions and pivotally mounted to said bracket;
c) connecting means for associating the electric powered drive means to proximate said lever arm first end region, wherein said connection means comprises:
i) first rotational anchoring means associated with said lever arm first end region and
ii) first attachment means extending between said first rotational anchoring means and the electric power drive means, wherein said first attachment means comprises:
a first coupling rod with first and second ends, wherein said first coupling rod first end is rotationally mounted to said rotational anchoring means;
a first wheel with an outer perimeter, wherein said first coupling rod second end rotationally attaches proximate said first wheel outer perimeter; and
first linkage means for connecting said first wheel to the electric power drive means, wherein said electric power drive means is an electric motor;
d) a rotational output drive shaft coupled to the output device;
e) linking means for associating said lever arm second region to said output drive shaft, wherein said linking means for associating said lever arm second region to said output drive shaft comprises:
i) second rotational anchoring means associated with said lever arm second end region and
ii) second attachment means extending between said second rotational anchoring means and said output drive shaft, wherein said second attachment means comprises:
a second coupling rod with first and second ends, wherein said second coupling rod first end is rotationally mounted to said second rotational anchoring means;
a second wheel with an outer perimeter, wherein said second coupling rod second end rotationally attaches proximate said second wheel outer perimeter; and
second linkage means for connecting said second wheel to the output device; and
f) electricity input gating means secured to said output drive shaft and in electrical communication with the electric powered drive means for activating and deactivating at selected time intervals the flow of electricity to the electric powered drive means.

19. An electromechanical coupler according to claim 18, wherein said electricity input gating means comprises:
a) means for detecting a rotational position of said output drive shaft and
b) means for activating and deactivating the flow of electricity to the electric power drive means based on said detected rotational position of said output drive shaft.

20. An electromechanical coupler according to claim 19, wherein said rotational position detection means comprises optical sensors and said activating and deactivating means comprises a computer controller in communication between said optical sensors and said electric power drive means.

21. An electromechanical coupler according to claim 18, wherein said electricity input gating means comprises:
a) a timing wheel having a center axis and first and second perimeter edges mounted through said center axis to said rotational output drive shaft, wherein as said rotational output drive shaft rotates said timing wheel rotates and said first perimeter edge is at a greater distance from said center axis than said second perimeter edge and
b) an electrical switch, wherein said electrical switch activates the flow of electricity to the electric powered drive means when said electrical switch encounters said first perimeter edge and deactivates the flow of electricity to electric powered drive means when said electrical switch encounters said second perimeter edge.
